(19) United States
(12) Patent Application Publication
(10) Pub. No.: US 2012/0171412 A1
(43) Pub. Date: Jul. 5, 2012

(54) ALUMINA TITANATE POROUS STRUCTURE

(75) Inventors: Stephane Raffy, Cavaillon (FR); Nabil Nahas, Serris (FR)

(73) Assignee: SAINT-GOBAIN CENTRE DE RECHERCHES ET D'ETUDES EUROPEEN, Courbevoie (FR)

(21) Appl. No.: 13/395,787

(22) PCT Filed: Sep. 21, 2010
(86) PCT No.: PCT/FR2010/051969

§ 371 Date: Mar. 13, 2012

(30) Foreign Application Priority Data
Sep. 22, 2009 (FR) 0956500

(51) Int. Cl. B32B 3/12; C04B 35/10; C04B 35/478; C04B 35/46

(52) U.S. Cl. 428/116; 501/135; 501/136

(57) ABSTRACT

A porous structure comprising a ceramic material, mainly formed by or consisting of an oxide material comprising titanium, aluminum, zirconium and silicium satisfying the following composition, in wt % on the basis of the oxides:
more than 15% but less than 55% Al₂O₃;
more than 20% but less than 45% TiO₂;
more than 1% but less than 30% SiO₂;
more than 0.7% but less than 20%, in total, of at least one oxide chosen from ZrO₂, Ce₂O₃ and HfO₂;
less than 1% MgO;
   said composition furthermore comprising other elements chosen, on the basis of oxides, from CaO, Na₂O, K₂O, SrO, B₂O₃ and BaO, the total summed amount of said oxides being less than 15% but greater than 1%; and said material being obtained by reactive sintering of said simple oxides or of one of their precursors, or by heat treatment of sintered particles, satisfying said composition.

The invention relates to a porous structure such as a catalyst support or a particulate filter, the material constituting the filtering and/or active portion of which is based on aluminum titanate. The ceramic material forming the basis of the ceramic filters or supports according to the present invention are predominantly formed from oxides of the elements Al, Ti. The porous structures usually have a honeycomb structure and are used especially in an exhaust line of a diesel internal combustion engine, the properties of which are improved.

In the rest of the description, said oxides comprising the elements will be described, for convenience and in accordance with the practice in the field of ceramics, by reference to the corresponding simple oxides, for example Al₂O₃ or TiO₂. In particular, in the following description, unless mentioned otherwise, the proportions of the various elements constituting the oxides according to the invention are given by reference to the weight of the corresponding simple oxides, as percentages by weight relative to the sum of the oxides present in the chemical compositions described.

In the remainder of the description, the application and the advantages in the specific field of filters or catalyst supports for removing the pollutants contained in the exhaust gases coming from a gasoline or diesel internal combustion engine, to which field the invention relates, will be described. At the present time, structures for decontaminating exhaust gases all have in general a honeycomb structure.

As is known, during its use, a particulate filter is subjected to a succession of filtration (soot accumulation) and regeneration (soot removal) phases.

During filtration phases, the soot particles emitted by the engine are retained and deposited inside the filter. During regeneration phases, the soot particles are burnt off inside the filter, so as to restore the filtration properties thereof. It will therefore be understood that the mechanical strength properties both at low and high temperature of the material constituting the filter are of paramount importance for such an application.

At the present time, filters are mainly made of a porous ceramic material, especially silicon carbide or cordierite. Silicon carbide catalytic filters of this type are for example described in patent applications EP 816 065, EP 1 142 619, EP 1 455 923 or WO 2004/090294 and WO 2004/065088. Such filters make it possible to obtain chemically inert filtering structures of excellent thermal conductivity and having porosity characteristics, particularly average pore size and pore size distribution, which are ideal for the application of filtering soot output by a thermal engine.

However, some drawbacks specific to this material still remain: a first drawback is due to the somewhat high thermal expansion coefficient of SiC, greater than 3×10⁻⁶ K⁻¹, which does not permit large monolithic filters to be manufactured and very often requires the filter to be segmented into several honeycomb elements bonded together using a cement, such as that described in patent application EP 1 455 923. A second drawback, of economic nature, is due to the extremely high firing temperature, typically above 2100° C. for sintering, ensuring a sufficient thermomechanical strength of the honeycomb structures, especially during the successive regeneration phases of the filter. Such temperatures require the installation of special equipment, appreciably increasing the cost of the filter finally obtained.

From another standpoint, although cordierite filters have been known and used for a long time, owing to their low cost, it is known at the present time that problems may arise in such structures, especially during poorly controlled regeneration cycles during which the filter may be locally subjected to temperatures above the melting point of cordierite. The consequences of these hot spots may range from a partial loss of efficiency of the filter to its complete destruction in the severest cases. Furthermore, the chemical inertness of cordierite is insufficient at the temperatures reached during the successive regeneration cycles and consequently it is liable to react with and be corroded by the substances originating from the lubricant, fuel, oil and other residues that have accumulated in the structure during the filtration phases, which phenomenon may also be the cause of the rapid deterioration in the properties of the structure.

For example, such drawbacks have been described in the patent application WO 2004/011124 which proposes, to remedy them, a filter based on aluminum titanate (60 to wt %) reinforced with mullite (10 to 40 wt %), the durability of which is improved.

According to another embodiment, patent application EP 1 559 696 proposes the use of powders for the manufacture of honeycomb filters obtained by reactive sintering of aluminum, titanium and magnesium oxides between 1000 and 1700° C. The material obtained after sintering takes the form of a blend of two phases: a predominant phase of the pseudobrookite structural type Al₂TiO₅ containing titanium, aluminum and magnesium, and a minor feldspar phase of the Na_{y}K_{1-y}AlSi₃O₈ type.

The object of the present invention is thus to provide a porous structure comprising an alternative, oxide-based material, having properties, especially in terms of thermal expansion coefficient, porosity and mechanical strength, which are improved so as to make it more advantageous to use them for the manufacture of a filtering and/or catalytic porous structure, typically a honeycomb structure.

The compromise between mechanical strength and porosity is evaluated by the characteristic value MOR×OP (modulus of rupture in compression multiplied by the open porosity volume), the higher value reflecting a better compromise between the porosity properties and the mechanical strength properties.

More precisely, the present invention relates to a porous structure comprising a ceramic material, the chemical composition of which comprises, in wt % on the basis of the oxides:
more than 15% but less than 55% Al₂O₃;
more than 20% but less than 45% TiO₂;
more than 3.5% but less than 30% SiO₂;
more than 0.7% but less than 20%, in total, of at least one oxide chosen from ZrO₂, Ce₂O₃ and HfO₂;
less than 1% MgO;
less than 0.7% Fe₂O₃;
   said composition furthermore comprising other elements chosen, on the basis of the oxides, from CaO, Na₂O, K₂O, SrO, B₂O₃ and BaO, the total summed amount of said oxides being less than 15% but greater than 1% and said material being obtained by the reactive sintering of said simple oxides or of one of their precursors, or by heat treatment of sintered particles satisfying said composition.

Preferably, the porous structure is formed by said ceramic material.

Preferably, Al₂O₃ represents more than 20% of the chemical composition, the percentages being given by weight on the basis of the oxides corresponding to the elements present. For example, especially for the filter or catalytic support application, Al₂O₃ may represent more than 25% and preferably even more than 35% of the chemical composition. Preferably, Al₂O₃ represents less than 54% or less than 53% of the chemical composition, the percentages being given by weight on the basis of the oxides.

Preferably, when SiO₂ represents more than 10% of the chemical composition, Al₂O₃ represents less than 52% or less than 51% of the chemical composition, the percentages being given by weight on the basis of the oxides.

Preferably, TiO₂ represents more than 22% and very preferably more than 25% of the chemical composition. Preferably, TiO₂ represents less than 43%, or less than 40% or even less than 38% of the chemical composition, the percentages being given by weight on the basis of the oxides.

Preferably, SiO₂ represents more than 2%, or more than 3% or more than 3.5% of the chemical composition. Preferably, SiO₂ represents less than 25% and very preferably less than 20% of the chemical composition, the percentages being given by weight on the basis of the oxides.

Preferably, the oxide(s) ZrO₂ and/or Ce₂O₃ and/or HfO₂ represents/represent in their entirety more than 0.8% and very preferably more than 1% or even more than 2% of the chemical composition, the percentages being given by weight on the basis of the oxides. Preferably, the oxide(s) ZrO₂ and/or Ce₂O₃ and/or HfO₂ represents/represent in total less than 10% and very preferably less than 8% of the chemical composition. According to one possible embodiment, the composition comprises only zirconium oxide in the proportions described above.

In the compositions given above, according to another possible, and preferred, embodiment of the invention, the ZrO₂ may thus be replaced, in the same proportions, with a combination of ZrO₂ and Ce₂O₃, provided that the ZrO₂ content remains greater than 0.7% or greater than 0.8% or greater than 1%. For example, in such a case said material comprises more than 0.8 wt % but less than 10 wt %, and very preferably less than 8 wt %, of (ZrO₂+Ce₂O₃), where (ZrO₂+Ce₂O₃) is the sum of the weight contents of the two oxides in said composition.

Of course in the context of the present description, it is possible for the composition nevertheless to comprise other compounds in the form of inevitable impurities. In particular, even when only one reactant containing zirconium is initially introduced in the process for manufacturing a structure according to the invention, it is known that said reactants usually comprise a small amount of hafnium, in the form of an inevitable impurity, which may sometimes be up to 1 or 2 mol % of the total amount of zirconium introduced.

Preferably, MgO represents less than 0.9%, or less than 0.5% or even less than 0.1% of the chemical composition by weight on the basis of the oxides.

The porous structure contains other elements such as boron, alkali metals or alkaline-earth metals of the type Ca, Sr, Na, K, Ba, the total summed amount of said elements present preferably being less than 15% by weight, for example less than 13%, or 12% by weight on the basis of the corresponding oxides B₂O₃, CaO, SrO, Na₂O, K₂O, BaO, in addition to the contents by weight of all the oxides corresponding to the elements present in said porous structure. The total summed amount of said oxides may represent more than 1%, or more than 2%, or more than 4%, or more than 5% or even more than 6% of the chemical composition.

Preferably, in the compositions of the structures according to the invention it is necessary, in order to obtain a higher porosity, to limit the concentration of the species Na and K. In particular according to a preferred embodiment of the invention, the sum of the oxides Na₂O and K₂O in the composition in the oxide material constituting the structure is preferably less than 1 wt %.

The chemical composition according to the invention may furthermore comprise other minor elements.

The chemical composition may in fact comprise other elements such as Co, Fe, Cr, Mn, La, Y and Ga, the total summed amount of said elements present being preferably less than 2 wt %, for example less than 1.5 wt % or even less than 1.2 wt % on the basis of the corresponding oxides CoO, Fe₂O₃, Cr₂O₃, MnO₂, La₂O₃, Y₂O₃ and Ga₂O₃, relative to the weight of all the oxides present in said composition. The percentage by weight of each minor element, on the basis of the weight of the corresponding oxide, is preferably less than 0.7%, or less than 0.6% or even less than 0.5%.

So as not to unnecessarily burden the present description, all possible combinations according to the invention between the various preferred embodiments of the compositions of materials according to the invention, as described above, will not be reported. However, of course all possible combinations of the initial and/or preferred values and fields described above may be envisioned and must be considered as described by the Applicant within the context of the present description (especially two, three or more combinations).

The porous structure according to the invention may furthermore comprise mainly or be formed by an oxide phase of the aluminum titanate type, at least one silicate phase and a phase essentially consisting of titanium oxide TiO₂ and/or zirconium oxide ZrO₂ and/or cerium oxide CeO₂ and/or hafnium oxide HfO₂.

The silicate phase or phases are in proportions that may range from 5 to 50% of the total weight of the material, preferably from 8 to 45% and very preferably from 10 to 40% of the total weight of the material. According to the invention, said silicate phase(s) may consist mainly of silica and alumina. Preferably, the proportion of silica in said silicate phase(s) is greater than 30% or greater than 35%.

Most particularly, the porous structure according to the invention may advantageously comprise a main oxide phase of the aluminum titanate type and have the following composition, in percentages by weight on the basis of the oxides:
more than 35% but less than 53% Al₂O₃;
more than 25% but less than 40% TiO₂;
more than 2% but less than 20% SiO₂;
more than 1% but less than 5% ZrO₂;
less than 1% MgO;
less than 0.7% Fe₂O₃; and
more than 2% but less than 13%, in total, of at least one oxide chosen from the group formed by CaO, Na₂O, K₂O, SrO, B₂O₃ and BaO.

The material constituting the porous structure according to the invention may be obtained by any technique normally used in the field.

According to a first variant, the material constituting the structure may be obtained directly, in the conventional manner, by simply mixing the initial reactants in the appropriate proportions for obtaining the desired composition, followed by heating and reaction in the solid state (reactive sintering).

Said reactants may be the simple oxides Al₂O₃, TiO₂, for example, and optionally other oxides of elements liable to be in the structure, for example in the form of a solid solution. It is also possible according to the invention to use any precursor of said oxides, for example in the form of carbonates, hydroxides or other organometallics of the above elements. The term “precursor” is understood to mean a material which decomposes into a simple oxide corresponding to a stage often prior to the heat treatment, i.e. at a heating temperature typically below 1000° C., or below 800° C. or even below 500° C.

According to another method of manufacturing the structure according to the invention, said reactants are sintered particles which correspond to the chemical composition as mentioned above and obtained from said simple oxides. The blend of the initial reactants is presintered, i.e. it is heated to a temperature allowing the simple oxides to react so as to form sintered particles comprising at least one main phase of structure of the aluminum titanate type. It is also possible according to this embodiment to use precursors of said aforementioned oxides. Again, as above, the blend of precursors is sintered, that is to say it is heated to a temperature allowing the precursors to react so as to form sintered particles comprising predominantly at least one phase having a structure of the aluminum titanate type, and then ground in order to obtain initial reactants.

One process for manufacturing such a structure according to the invention is in general the following: Firstly, the initial reactants are blended in the appropriate proportions for obtaining the desired composition.

In a manner well known in the field, the manufacturing process typically includes a step of mixing the initial blend of reactants with an organic binder of the methyl cellulose type and a pore former for example such as: starch, graphite, polyethylene, PMMA, etc. and the progressive addition of water until the plasticity needed to allow the step of extruding the honeycomb structure is obtained.

For example, during the first step, the initial blend is mixed with 1 to 30 wt % of at least one pore-forming agent chosen according to the desired pore size, and then at least one organic plasticizer and/or an organic binder and water are added.

The mixing results in a homogeneous product in the form of a paste. The step of extruding this product through a die of suitable shape makes it possible, using well-known techniques, to obtain honeycomb-shaped monoliths. The process may for example then include a step of drying the monoliths obtained. During the drying step, the green ceramic monoliths obtained are typically dried by microwave drying or by thermal drying, for a time sufficient to bring the non-chemically-bound water content to less than 1 wt. %⁻. When it is desired to obtain a particulate filter, the process may further include a step of blocking every other channel at each end of the monolith.

The step of firing the monoliths, the filtering portion of which is based on aluminum titanate, is in principle carried out at a temperature above 1300° C. but not exceeding 1800° C., preferably not exceeding 1750° C. The temperature is adjusted in particular according to the other phases and/or oxides that are present in the porous material. Usually, during the firing step, the monolith structure is heated to a temperature of between 1300° C. and 1600° C. in an atmosphere containing oxygen or an inert gas.

Although one of the advantages of the invention lies in the possibility of obtaining monolithic structures of greatly increased size without the need for segmentation, unlike SiC filters (as described above), according to one embodiment which is not, however, preferred, the process may optionally include a step of assembling the monoliths into a filtration structure assembled using well-known techniques, for example those described in patent application EP 816 065.

The filtering structure or the catalyst support made of porous ceramic material according to the invention is preferably of the honeycomb type and has a suitable porosity of greater than 10%, with a pore size centered between 5 and 60 microns, in particular between 20 and 70%, preferably between 30 and 60%, the average pore size being ideally between 10 and 20 microns, as measured by mercury porosimetry on a Micromeritics 9500 apparatus.

Such filtering structures typically have a central portion comprising a number of adjacent ducts or channels of mutually parallel axes that are separated by walls formed by the porous material.

In a particulate filter, the ducts are closed off by plugs at one or other of their ends so as to define inlet chambers opening onto a gas entry face and outlet chambers opening onto a gas discharge face, in such a way that the gas passes through the porous walls.

The present invention also relates to a filter or to a catalyst support obtained from a structure as defined above and by depositing, preferably by impregnation, at least one active catalytic phase, which is supported or preferably not supported, typically comprising at least one precious metal, such as Pt and/or Rh and/or Pd and optionally an oxide such as CeO₂, ZrO₂ or CeO₂—ZrO₂. The catalyst supports also have a honeycomb structure, but the ducts are not closed off by plugs and the catalyst is deposited in the pores of the channels.

The invention and its advantages will be better understood on reading the following non-limiting examples. In the examples, unless otherwise mentioned, all the percentage content are given by weight.

### EXAMPLES

In the examples, the specimens were prepared from the following raw materials:
Almatis CL4400FG alumina comprising 99.8% Al₂O₃ and having a median diameter d₅₀ of about 5.2 μm;
TRONOX T-R titanium oxide comprising 99.5% TiO₂ and having a diameter of around 0.3 μm;
SiO₂ Elkem Microsilicia Grade 971U having a purity of 99.7%;
lime comprising about 97% CaO, with more than 80% of the particles having a diameter of less than 80 μm;
strontium carbonate comprising more than 98.5% SrCO₃, sold by Societe des Produits Chimiques Harbonniéres; and
zirconia having a purity of greater than 98.5% and a median diameter d₅₀ of 3.5 μm, sold under the reference CC10 by the company Saint-Gobain ZirPro.

The specimens according to the invention and the comparative specimens were obtained from the above reactants, blended in the appropriate proportions.

More precisely, the blends of the initial reactants were blended then pressed in the form of cylinders which are then sintered at the temperature indicated in Table 1 for 4 hours in air at 1450° C. (series of examples 1) or at 1500° C. (series of examples 2). The specimens or materials of the following examples were thus obtained.

The prepared specimens were then analyzed. The results of the analyses carried out on each of the specimens of the examples are given in Table 1.

### In Table 1:

1) the chemical composition, indicated in wt % on the basis of the oxides, was determined by X-ray fluorescence;

2) the crystalline phases present in the refractory products were characterized by X-ray diffraction and microprobe analysis EPMA (Electron Probe Micro Analyser). On the basis of the results thus obtained, the weight percentage of each phase and its composition was able to be estimated. In Table 1, AT indicates a solid solution of oxides Al₂O₃ and TiO₂ (main phase), PS indicates the presence of a silicate phase, other phase(s) indicate(s) the presence of at least one other minor phase P2 and “˜” means that the phase is present in trace form;

3) the compressive strength (R) is determined at room temperature, on a LLOYD machine equipped with a 10 kN load cell, by compressing the prepared specimens at a rate of 1 mm/min; and

4) the density was measured by conventional techniques (Archimedes method). The porosity given in table 1 corresponds to the difference, given as a percentage, between the theoretical density (the expected maximum density of the material in the absence of any porosity and measured by helium picnometry on the ground product) and the measured density.

TABLE 1
Table 1

| Example | | 1 | Comp. 1 | 2 | Comp. 2 | 1a | Comp. 1a |
|---|---|---|---|---|---|---|---|
| Al₂O₃ | | 51.0 | 53.6 | 51.0 | 53.6 | 50.3 | 52.5 |
| TiO₂ | | 36.4 | 38.3 | 36.4 | 38.3 | 31.7 | 37.5 |
| Fe₂O₃ | | 0.6 | 0.7 | 0.6 | 0.7 | 0.4 | |
| SiO₂ | | 4.0 | 4.2 | 4.0 | 4.2 | 7.5 | 4.5 |
| SrO | | 2.1 | 2.2 | 2.1 | 2.2 | 4.4 | |
| CaO | | 0.3 | 0.3 | 0.3 | 0.3 | 0.5 | |
| MgO | | <0.1 | <0.1 | <0.1 | <0.1 | <0.1 | <0.1 |
| Na₂O | | 0.15 | 0.16 | 0.15 | 0.16 | 0, .15 | |
| ZrO₂ | | 5.4 | 0.4 | 5.4 | 0.4 | 5.0 | 5.5 |
| Phases | AT (main) | yes | yes | yes | yes | yes | yes |
| | PS | yes | yes | yes | yes | yes | yes |
| | other: P2 | yes | — | yes | — | yes | yes |

| | | | | | | |
|---|---|---|---|---|---|---|
| 4-hour sintering | 1450 | 1450 | 1500 | 1500 | 1450 | 1450 |
| temperature (° C.) | | | | | | |
| Density | 2.49 | 2.30 | 2.79 | 2.52 | 2.61 | 2.87 |
| Porosity | 34.3 | 37.9 | 29.2 | 32.0 | 25.2 | 18.8 |
| R (MPa) | 48.8 | 32.1 | 39.9 | 32.5 | 68.4 | 77.5 |
| R × Porosity | 1674 | 1217 | 1144 | 1104 | 1723 | 1457 |

Comparative examples 1 and 2 relate to structures not in accordance with the invention in that they contain too low a level of zirconium or strontium. From the data of Table 1, it may be seen that there is an improvement in the combined porosity and mechanical strength characteristics: for the same sintering or firing temperature, the table shows that the porosity of the example according to the invention is comparable to that of the comparative example. At the same time, as indicated in Table 1, the example according to the invention has a significantly higher strength R than that of the comparative example.

By comparing the above data, it may be seen that the porous structure obtained according to the present invention exhibits a significantly improved compromise between mechanical strength and porosity. Importantly, it thus may be seen that the product MOR×OP (modulus of rupture in compression multiplied by the open porosity volume), representing the compromise between mechanical strength and porosity, is systematically higher for the porous body according to the invention for the same sintering temperature. Thus, examples 1 and 1a, corresponding to the composition according to the main claim appended hereto and comprising more than 3.5% SiO₂ and more than 1% in total of the oxides CaO, Na₂O, K₂O, SrO, B₂O₃ and BaO, exhibit the best compromises, compared with comparative example 1 (ZrO₂ content less than 0.7%) and comparative example la (CaO, Na₂O, K₂O, SrO, B₂O₃ and BaO content less than 1%).

Thus, the products of the invention make it possible, depending on the requirement:
either to obtain better properties associated with a desired composition of the material at a set firing temperature;
or else to adjust a high porosity level of the material (in particular by the addition of a pore former to the initial reactants) while maintaining good mechanical integrity.

1. A porous structure comprising a ceramic material comprising oxides in a composition, in wt % based on a total amount of oxides, of:
more than 15% but less than 55% Al₂O₃;
more than 20% but less than 45% TiO₂;
more than 3.5% but less than 30% SiO₂;
more than 0.7% but less than 20%, in total, of at least one oxide chosen selected from ZrO₂, Ce₂O₃ and HfO₂;
less than 1% MgO;
less than 0.7% Fe₂O₃;
more than 1% but less than 15%, in total, of at least one oxide selected from CaO, Na₂O, K₂O, SrO, B₂O₃ and BaO;
wherein the ceramic material is obtained by reactive sintering of the oxides or of an oxide precursor, or by heat treatment of sintered particles having the composition.

2. The porous structure of claim 1, wherein the ceramic material comprises more than 0.8%, in total, of at least one oxide selected from ZrO₂, Ce₂O₃ and HfO₂.

3. The porous structure of claim 1, wherein the at least one oxide selected from ZrO₂, Ce₂O₃ and HfO₂ is ZrO₂.

4. The porous structure of claim 1, wherein the at least one oxide selected from ZrO₂, Ce₂O₃ and HfO₂ are ZrO₂ and Ce₂O₃, and the ceramic material comprises more than 0.7% ZrO₂.

5. The porous structure of claim 1, wherein the ceramic material comprises less than 54% Al₂O₃.

6. The porous structure as claimed in of claim 1, wherein the ceramic material comprises more than 22% TiO₂.

7. The porous structure of claim 1, wherein the ceramic material comprises less than 43% TiO₂.

8. The porous structure of claim 1, wherein the ceramic material comprises less than 25% SiO₂.

9. The porous structure of claim 1, wherein the ceramic material comprises less than 0.5% MgO.

10. The porous structure of claim 1, wherein the ceramic material comprises less than 10%, in total, of the at least one oxide selected from ZrO₂, Ce₂O₃ and HfO₂.

11. The porous structure of claim 1, wherein the ceramic material comprises less than 13%, in total, of the at least one oxide selected from CaO, Na₂O, K₂O, SrO, B₂O₃ and BaO.

12. The porous structure of claim 1, wherein the ceramic material comprises more than 2%, in total, of the at least one oxide selected from CaO, Na₂O, K₂O, SrO, B₂O₃ and BaO.

13. The porous structure of claim 1, wherein the ceramic material comprises less than 1% of a summed amount of Na₂O and K₂O.

14. The porous structure of claim 1, wherein the ceramic material comprises a main phase formed by an aluminum titanate type phase, a silicate phase and a phase comprising at least one oxide selected from the group consisting of TiO₂, ZrO₂, CeO₂ and HfO₂.

15. The porous structure of claim 14, wherein the ceramic material comprises 5 to 50% of the silicate phase, based on a total weight of the ceramic material.

16. The porous structure of claim 1, having a honeycomb type structure, wherein the ceramic material has a porosity of greater than 10% and a pore size centered between 5 and 60 microns.

17. The porous structure of claim 1, wherein the ceramic material comprises more than 25% but less than 38% TiO₂.

18. The porous structure of claim 1, wherein the ceramic material comprises more than 2% SrO.

19. The porous structure of claim 1, wherein the ceramic material comprises 5% or more ZrO₂.

20. The porous structure of claim 1, wherein the ceramic material comprises
more than 25% but less than 38% TiO₂;
more than 2% SrO; and
5% or more ZrO₂.
